(19) United States
(12) Patent Application Publication
(10) Pub. No.: US 2005/0040272 A1
(43) Pub. Date: Feb. 24, 2005

(54) Cartridge with slanted memory chip and conforming wall

(76) Inventors: Armando Jesus Argumedo, Tucson, AZ (US); Edwin Ralph Childers, Tucson, AZ (US); Reed Alan Hancock, Tucson, AZ (US); Joseph Chase Ramirez, Tucson, AZ (US)

Correspondence Address: QUARLES & BRADY STREICH LANG, LLP, ONE SOUTH CHURCH AVENUE, SUITE 1700, TUCSON, AZ, 85701-1621, US

(21) Appl. No.: 10/643,619

(22) Filed: Aug. 19, 2003

(51) Int. Cl. G11B 23/107; G06K 19/00

(52) U.S. Cl. 242/348; 235/487

(57) ABSTRACT

A magnetic-tape cartridge case has the same general geometry and dimensions of a conventional cartridge, but an additional slanted wall is incorporated between two other walls at one end of the cartridge case. A memory chip is placed with its antenna adjacent to the additional wall inside the case. The memory chip is accessible by non-contact means from two substantially orthogonal directions and the antenna of the external reading device may be placed in closer proximity than heretofore possible and may be optimally oriented to improve data transmission.

### BACKGROUND OF THE INVENTION

1. Field of the Invention

This invention relates generally to data cartridges that incorporate a memory device for data storage and transmission. In particular, the invention concerns a specific data-cartridge geometry for radio-frequency communication with external reading devices along multiple orthogonal axes.

2. Description of the Related Art

The portability of magnetic tape cartridges makes it possible to store large amounts of data in separate cartridges that can then be stored in libraries for repeated use or archived for future use. Such data cartridges often include a memory chip with information that is more readily accessible than the data stored on the tape by establishing a connection with external reading devices. Thus, the information carried in the memory chip can be quickly accessed without reading the contents of the tape.

According to earlier implementations of this concept, the memory chip inside the cartridge is connected to electrical conductors that extend to the outer surface of at least one of the walls of the cartridge case. An external reading device, typically mounted in a tape drive, is adapted to contact the electrical conductors in order to energize the memory chip and receive its contents through the conductors. In other implementations of the concept, an antenna is coupled to the memory chip for non-contact data transmission. A second antenna, coupled to the reading device, is used to energize the chip and receiving its contents using a magnetic field. See, for example, Patent Publications JP2002117644, JP2002140879, US20010011012, US20030002214 and US20030021058.

In order to allow communication with external devices along multiple axes, the antenna associated with the memory chip in the cartridge has been extended in multiple directions, such as along the rear and side walls or the back and bottom walls of the cartridge case. Accordingly, data may be received by reading devices placed at orthogonal directions with respect to the cartridge. In a two-axis implementation of this concept disclosed in U.S. Pat. No. 6,304,416, the memory chip and antenna are positioned at a 45-degree angle with respect to the rear and bottom walls of the cartridge case, thereby enabling transmission along both the horizontal and vertical planes. The antenna and memory chip are anchored to the inner surfaces of the walls of the cartridge case so as to minimize the distance from the antenna of the external reading device while in operation.

Thus, non-contact magnetic-field data transmission along two orthogonal axes has been achieved with a memory-chip device mounted at an angle inside the tape cartridge. Because of magnetic-field power limitations, these devices necessarily operate at very low power levels (in the order of 50 milliwatts). On the other hand, a sufficiently strong field needs to be propagated to energize the memory chip and effectively transmit data between antennas. Thus, it is very desirable to eliminate any structural component in the cartridge that attenuates the data-transmission signal and to minimize the distance between the memory-chip antenna and the antenna of the reading device outside the tape cartridge. This invention provides a novel cartridge case designed to optimize these objectives.

### BRIEF SUMMARY OF THE INVENTION

According to the principles of the present invention, a tape cartridge case has the same general geometry and dimensions of a conventional cartridge, but an additional slanted wall is incorporated between two other walls at one end of the cartridge case. A memory chip is placed with its antenna adjacent to the additional wall inside the case. Thus, the memory chip may be accessed by non-contact means from two substantially orthogonal directions.

According to one desirable aspect of the invention, the memory-chip/antenna device may be attached to the case without supporting ribs or other structural components that inhibit the free propagation of the electromagnetic wavefront between the antennas of the memory chip and the reading device. According to another, most advantageous aspect, the elimination of the corner between two perpendicular walls of the cartridge case allows the external reading device to be placed closer to the antenna of the memory chip inside the cartridge. As a result, improved data transmission is achieved with the very low RF power levels normally used for energizing the memory chip.

In the preferred embodiment of the invention, the slanted wall and the antenna of the memory chip are oriented at approximately 45 degrees with respect to the adjacent cartridge walls. The slanted wall is disposed between the rear and the bottom walls of the cartridge case and the resulting free space outside the case (the space contained within the imaginary corner defined by the intersection of the planes of the rear and bottom walls) is used to minimize the distance between the memory-chip antenna and the one or two reader antennas facing the rear and/or bottom walls when the cartridge is in place for data transmission.

Various other purposes and advantages of the invention will become clear from its description in the specification that follows and from the novel features particularly pointed out in the appended claims. Therefore, to the accomplishment of the objectives described above, this invention consists of the features hereinafter illustrated in the drawings, fully described in the detailed description of the preferred embodiment and particularly pointed out in the claims. However, such drawings and description disclose only some of the various ways in which the invention may be practiced.

### BRIEF DESCRIPTION OF THE DRAWINGS

FIG. 1 is a front perspective view of a tape cartridge according to the invention with the top portion of the casing removed.

FIG. 2 is a rear perspective view of the cartridge of FIG. 1.

FIG. 3 is a partially cut-out side elevational view of the cartridge of FIG. 1 showing the slanted wall of the invention and a memory-chip antenna mounted on the inside of the wall.

FIG. 4 is a schematic side elevational view of the invention in an alternative application.

FIG. 5 is a schematic top view of an alternative embodiment of the invention.

FIG. 6 is a schematic side elevational view of another embodiment of the invention where the slanted wall is recessed from the rear wall of the cartridge.

FIG. 7 is a schematic side elevational view of another embodiment of the invention in the configuration of FIG. 1 where the memory-chip antenna is mounted on the exterior surface of the slanted wall.

### DESCRIPTION OF THE PREFERRED EMBODIMENTS OF THE INVENTION

The heart of this invention lies in the recognition that the elimination of a corner section from two adjacent walls in the casing of a conventional tape cartridge would reduce the space occupied by the cartridge when placed in operation for RF data transmission. Accordingly, the freed space advantageously enables the placement of the antennas of one or more external reading devices in closer proximity than heretofore possible to the antenna of the memory chip mounted inside the cartridge.

For the purposes of this disclosure, the terms rear and front are used throughout in connection with the structure of a typical tape cartridge described herein to refer to the side facing the gripper arms of an automated picker and the side facing the drive during use, respectively. Left and right refer to the cartridge lateral sides as they appear viewing the cartridge from its front side. The terms bottom and top are used with reference to the side of the cartridge that contains the tape reel and hub and to its parallel opposite side, respectively. The top and bottom sides are considered to lie on horizontal planes during normal use of the cartridge. The term slanted is used to refer to a wall that is disposed at an angle either with respect to a pair of horizontal and vertical walls or with respect to two vertical walls of the cartridge. Finally, the term angle is used to refer to the space defined by the intersection of two planes.

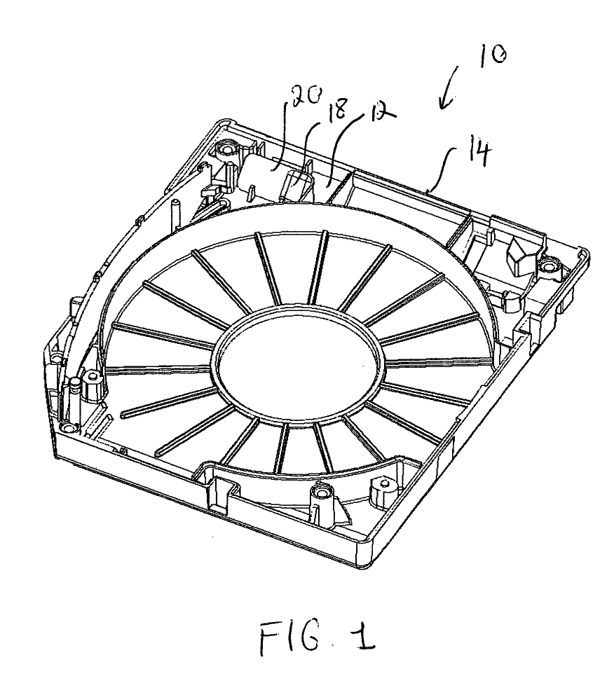

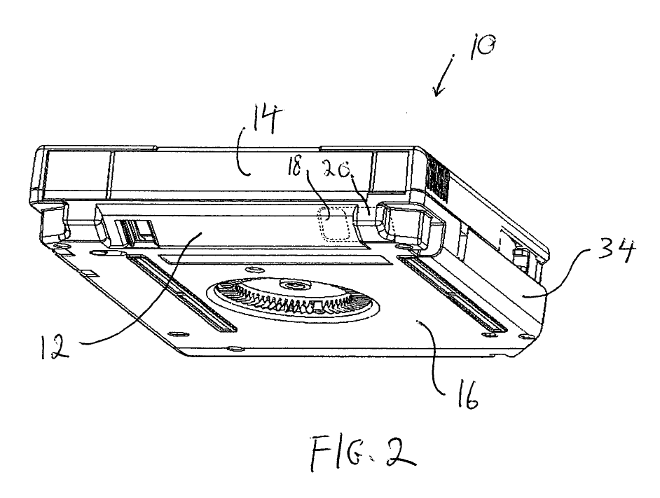

Referring to the drawings, wherein like parts are designated throughout with like numerals and symbols, FIGS. 1 and 2 illustrate in perspective top and bottom views, respectively, a magnetic-tape cartridge 10 according to the invention. Except for the modification pertinent to the invention, the case of the cartridge 10 conforms to the international standard specifications of a Magstar cartridge with modified lateral sides that permit its use with either a Magstar or an LTO type of automated picker, as described in U.S. Ser. No. 10/080,069. According to the preferred embodiment of the invention, a slanted wall 12 is added to the configuration of the cartridge case to connect the rear wall 14 with the bottom wall 16, thereby eliminating a rear-bottom corner section from the conventional parallelepiped geometry. A memory chip 18 with a corresponding antenna 20 is mounted adjacent to the inside surface of the slanted wall 12 for non-contact communication with one or more external devices. While both the wall 12 and the antenna 20 are preferably disposed at a 45-degree angle with respect to the rear and bottom walls 14,16, the angle of slant of each may be advantageously modified to optimize particular applications.

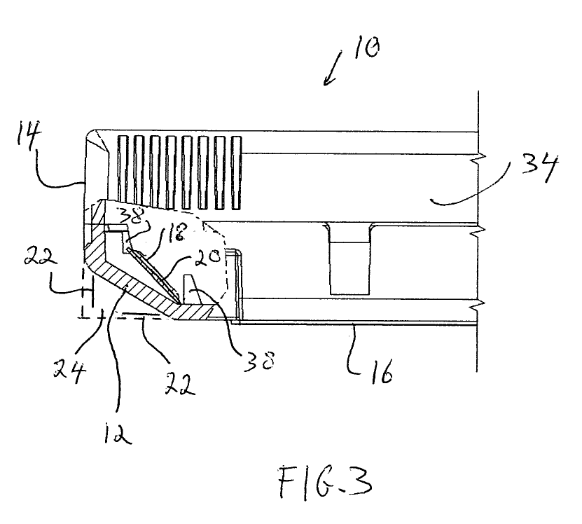

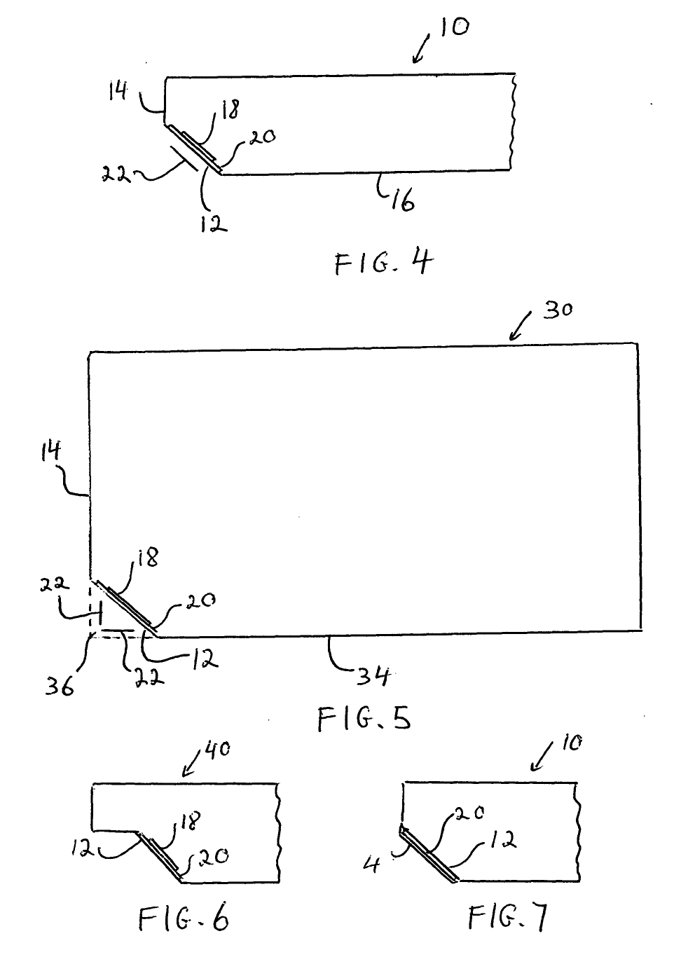

As a result of this configuration, the antenna 20 is capable of non-contact transmission in multiple directions including along vertical and horizontal planes parallel to the rear and bottom walls, respectively, as required for conventional two-axis communication. In addition, as illustrated in FIG. 3, the geometry of the cartridge 10 allows the placement of the antennas 22 of external reading devices (not shown) to be positioned within the space 24 immediately adjacent the outside surface of the wall 12 when the cartridge is transmitting data (that is, within the space demarcated by the intersection of two planes extending from the rear and bottom walls 14,16). This space, which in conventional cartridges is occupied by the lower rear corner section of the cartridge case, can be used advantageously according to the invention to reduce the distance between the external reading antenna and the memory chip. Moreover, because of the additional space available within the tape drive, library, or other system device where non-contact transmission is required, the antenna 22 of the external reading device (positioned either at the end or the bottom of the cartridge) may also be oriented to face the internal antenna 20 of the memory chip so as to further improve communication, as illustrated in the exemplary application of FIG. 4.

FIG. 5 illustrates schematically in top view another tape cartridge 30 according to the invention wherein a slanted wall 32 is used to connect the rear wall 14 with the left wall 34 of the cartridge case, thereby eliminating a rear-left corner section from the conventional cartridge geometry. The memory chip 18 with its antenna 20 is mounted adjacent to the inside surface of the slanted wall 32 for non-contact communication with external devices. As in the case of the embodiment of FIG. 1, the antenna 20 is capable of non-contact transmission in multiple directions including orthogonal horizontal axes parallel to the rear and left walls. In such a case, the antennas 22 of external reading devices (which may be at different cartridge stations) may also be positioned vertically within the space 36, as shown in the figure, and may be oriented to optimize reception as described above. Both the wall 32 and the antenna 20 are again preferably disposed at a 45-degree angle with respect to the rear and left walls 14,34.

According to another aspect of the invention intended to further improve non-contact communication between the internal and external antennas, the memory chip and antenna 18,20 are preferably attached to the inside surface of the slanted wall 12 (or 32, as applicable) using molded retaining features 38 in the case (see FIG. 3) or by conventional bonding means used in the art. Because of the similar slanted attitude of both the antenna and the supporting wall, the memory chip and antenna can be retained in the required slanted position within the case without resorting to triangular ribs or other structural components previously used in the art that might decrease the efficiency of reception and affect the quality of data transmission. Therefore, the slanted-wall solution of the invention provides this additional advantage with respect to prior-art memory chips mounted within the cartridge.

Thus, a new design for a magnetic-tape cartridge is provided which can be used to enhance transmission for multiple-axis non-contact communication. It is understood that the invention may be used with any cartridge format, such as Magstar or LTO, currently in use in the art. Moreover, the invention has been described with a slanted wall 12 that spans most of the length of the rear wall of the cartridge, but one skilled in the art would readily recognize that only the portion of wall facing the antenna 20 of the memory chip needs to be modified according to the invention. Similarly, the slanted wall could be recessed with respect to one or both of the adjacent walls, as illustrated in the embodiment 40 of FIG. 6, without affecting the performance of the invention. Finally, FIG. 1 and FIG. 5 illustrate the preferred embodiment 10 and an alternative embodiment 30 of the invention, but the same results could be achieved by implementing the slanted wall at the corners between any other pairs of conventional cartridge walls.

Various changes in the details, steps and components that have been described may be made by those skilled in the art within the principles and scope of the invention herein illustrated and defined in the appended claims. For example, the memory-chip antenna has been described as being attached to the interior surface of the slanted wall of the invention, but it is clear that equivalent embodiments could be obtained by incorporating the antenna within the wall itself, or by attaching it to the exterior surface of the wall, as illustrated in FIG. 7. In such a case, a highly transmissive protective layer 42 would be preferably used to coat the antenna 20.

Therefore, while the invention has been shown and described in what is believed to be the most practical and preferred embodiments, it is recognized that departures can be made therefrom within the scope of the invention, which is not to be limited to the details disclosed herein but is to be accorded the full scope of the claims so as to embrace any and all equivalent articles and processes.

1. A magnetic-tape cartridge, comprising:
a cartridge case having orthogonal walls in parallelepiped configuration and a slanted wall between two of the orthogonal walls; and
a memory device connected to an antenna capable of communication through a magnetic field propagated from the slanted wall along a plurality of transmission axes.

2. The cartridge of claim 1, wherein said antenna is positioned at about 45 degrees with respect to said two of the orthogonal walls of the case.

3. The cartridge of claim 1, wherein said slanted wall connects a rear wall and a bottom wall of the case.

4. The cartridge of claim 2, wherein said slanted wall connects a rear wall and a bottom wall of the case.

5. The cartridge of claim 1, wherein said antenna is adjacent to an interior surface of the slanted wall.

6. The cartridge of claim 4, wherein said antenna is adjacent to an interior surface of the slanted wall.

7. The cartridge of claim 1, wherein said antenna is adjacent to an exterior surface of the slanted wall.

8. The cartridge of claim 6, wherein said antenna is adjacent to an exterior surface of the slanted wall.

9. The cartridge of claim 1, wherein said slanted wall connects a rear wall and a side wall of the case.

10. The cartridge of claim 2, wherein said slanted wall connects a rear wall and a side wall of the case.

11. A system for communicating with a memory chip in a magnetic-tape cartridge, comprising:
a case for said cartridge having orthogonal walls in parallelepiped configuration and a slanted wall between two of the orthogonal walls;
a chip antenna connected to said memory device and capable of communication through a magnetic field propagated from the slanted wall; and
a reading antenna connected to an external reading device in magnetic-field communication with the chip antenna.

12. The system of claim 11, wherein said reading antenna in operation is positioned within a space demarcated by a corner defined by an intersection between planes extending from said two of the orthogonal walls.

13. The system of claim 11, wherein said chip antenna is positioned at about 45 degrees with respect to said two of the orthogonal walls of the case.

14. The system of claim 11, wherein said slanted wall is placed between a rear wall and a bottom wall of the case.

15. The system of claim 11, wherein said chip antenna is adjacent to an interior surface of the slanted wall.

16. The system of claim 11, wherein said chip antenna is adjacent to an exterior surface of the slanted wall.

17. The system of claim 16, further including a protective coating over the chip antenna.

18. A method for transmitting data between a memory device in a magnetic-tape cartridge and an external reading device, comprising the steps of:
providing a cartridge case having orthogonal walls in parallelepiped configuration and a slanted wall between two of said orthogonal walls;
connecting the memory device to a chip antenna capable of communication through a magnetic field propagated from the slanted wall;
providing a reading antenna connected to an external reading device in magnetic-field communication with the chip antenna; and
transmitting data between said chip and reading antennas through said magnetic field propagated from the slanted wall.

19. The method of claim 18, wherein said reading antenna is positioned within a space demarcated by a corner defined by an intersection between planes extending from said two of the orthogonal walls.

20. The method of claim 18, wherein said chip antenna is positioned at about 45 degrees with respect to said two of the orthogonal walls.

21. The method of claim 18, wherein said slanted wall is placed between a rear wall and a bottom wall of the case.

22. The method of claim 18, wherein said chip antenna is adjacent to an interior surface of the slanted wall.

23. The method of claim 18, wherein said chip antenna is adjacent to an exterior surface of the slanted wall.
